(19) United States
(12) Patent Application Publication
(10) Pub. No.: US 2023/0402789 A1
(43) Pub. Date: Dec. 14, 2023

(54) Connector, Mating Connector and Connector Assembly

(71) Applicant: Tyco Electronics (Shanghai) Co., Ltd., Shanghai (CN)

(72) Inventors: Dingbing (Frank) Fan, Shanghai (CN); Xiaozhi (George) Fu, Shanghai (CN); Wei Zhang, Shanghai (CN); Xianwei (Henry) Kong, Shanghai (CN); Shuzi (Lorry) Wang, Shanghai (CN)

(73) Assignee: Tyco Electronics (Shanghai) Co., Ltd., Shanghai (CN)

(21) Appl. No.: 18/332,802

(22) Filed: Jun. 12, 2023

(30) Foreign Application Priority Data
Jun. 10, 2022 (CN) 202221449070.1

(51) Int. Cl. H01R 13/627; H01R 12/75

(52) U.S. Cl. CPC H01R 13/6273; H01R 12/75; H01R 12/57

(57) ABSTRACT

A connector includes a housing, a terminal arranged in the housing, and an elastic cantilever on an outside of a top wall of the housing and extending along a length direction of the housing. The elastic cantilever has a pair of sides opposite to each other in a width direction of the housing. A snap protruding along the width direction is formed on one of the sides of the elastic cantilever. The snap engages a mating snap formed on a mating housing of a mating connector to lock the connector and the mating connector together.

### CROSS-REFERENCE TO RELATED APPLICATION

This application claims the benefit of the filing date under 35 U.S.C. § 119(a)-(d) of Chinese Patent Application No. 202221449070.1, filed on Jun. 10, 2022.

### FIELD OF THE INVENTION

The present invention relates to a connector, a mating connector mated to the connector, and a connector assembly comprising the connector and the mating connector.

### BACKGROUND

In the prior art, in order to lock the connector and mating connector in the mating state, an elastic fastener is usually formed on the top wall of the housing of the connector, and the elastic fastener has a convex part protruding along the height direction of the housing, which can be locked into a slot on the top wall of the housing of the mating connector. After the convex part is locked into the slot, the convex part can be separated from the slot by pressing the elastic fastener in the height direction.

When locking or unlocking the convex part, the elastic fastener needs to move in the height direction of the housing. Therefore, the spacing between the elastic fastener and the housing in the height direction is large, which can lead to a larger height dimension of the connector.

### SUMMARY

A connector includes a housing, a terminal arranged in the housing, and an elastic cantilever on an outside of a top wall of the housing and extending along a length direction of the housing. The elastic cantilever has a pair of sides opposite to each other in a width direction of the housing. A snap protruding along the width direction is formed on one of the sides of the elastic cantilever. The snap engages a mating snap formed on a mating housing of a mating connector to lock the connector and the mating connector together.

### BRIEF DESCRIPTION OF THE DRAWINGS

Features of the present invention will become more apparent by describing in detail exemplary embodiments thereof with reference to the accompanying drawings, in which:

FIG. 1 is an exploded perspective view of a connector assembly according to an embodiment;

FIG. 2 is a perspective view of the connector assembly;

FIG. 3 is another perspective view of the connector assembly;

FIG. 4 is a sectional perspective view of the connector assembly;

FIG. 5 is an exploded sectional perspective view of the connector assembly with a part of a top portion of the connector assembly removed;

FIG. 6 is a sectional perspective view of the connector assembly with the part of the top portion of the connector assembly removed; and

FIG. 7 is a bottom perspective view of a connector according to an embodiment.

### DETAILED DESCRIPTION OF EXEMPLARY EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

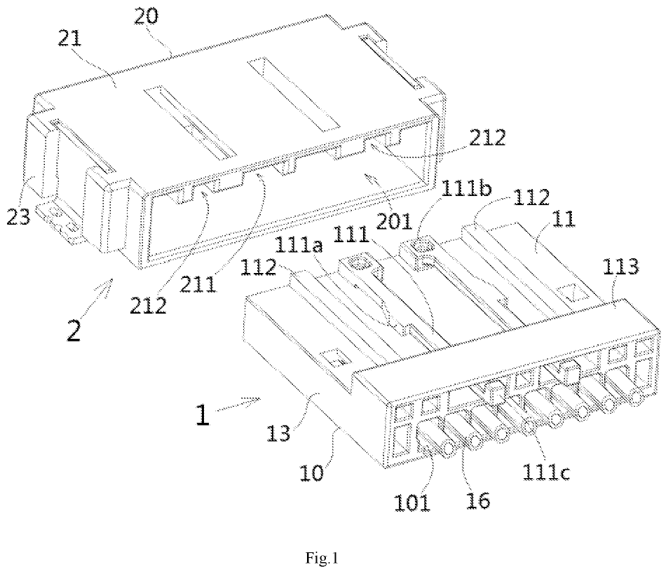

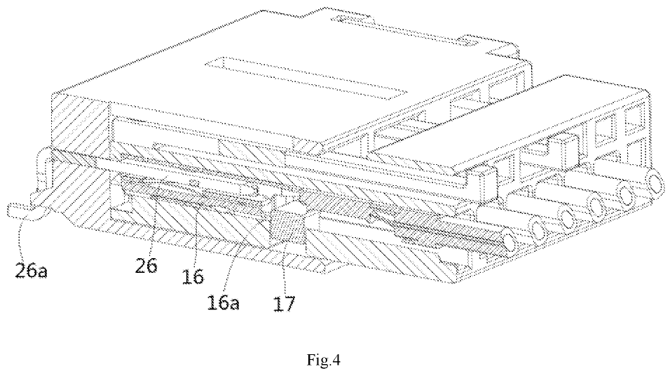

As shown in FIGS. 1 to 4, in the illustrated embodiment, the connector assembly includes a connector 1 and a mating connector 2. The mating connector 2 is adapted to mate with the connector 1.

The connector 1, as shown in FIG. 1, includes a housing 10, a terminal 16, and an elastic cantilever 111. The terminal 16 is provided in the housing 10. The elastic cantilever 111 is located outside a top wall 11 of the housing 10 and extends along the length direction of the housing 10.

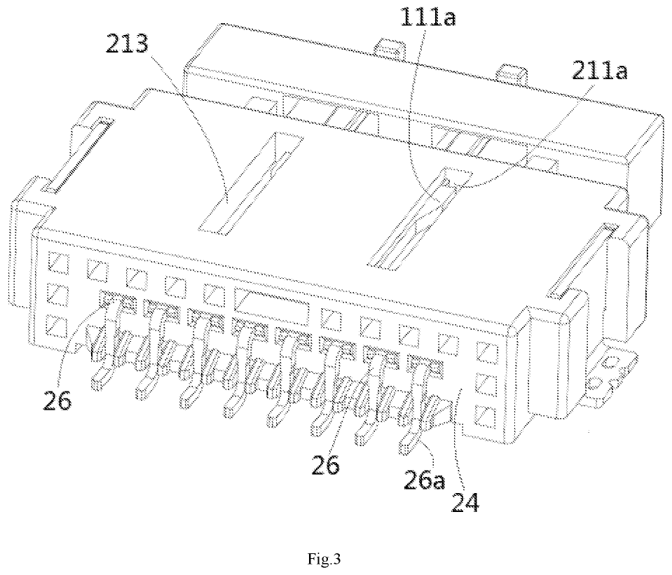

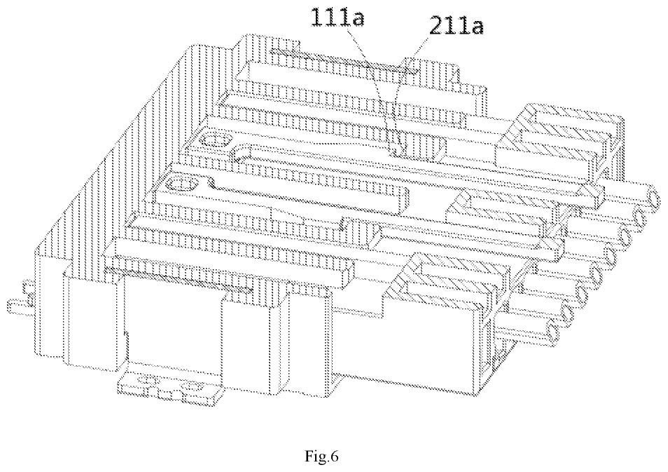

The elastic cantilever 111 has a pair of opposite sides in the width direction of the housing 10, and a snap 111a protruding in the width direction is formed on the side of the elastic cantilever 111, as shown in FIG. 1. The snap 111a is used to engage the mating snap 211a formed on the mating housing 20 of the mating connector 2, as shown in FIGS. 3 and 6, so as to lock the connector 1 and the mating connector 2 together.

As shown in FIG. 1, the elastic cantilever 111 has a front end 111b and a rear end 111c that are opposite in a length direction, and the front end 111b of the elastic cantilever 111 is fixed to the top wall 11 of the housing 10. After engaging the snap 111a with the mating snap 211a, the snap 111a can be separated from the mating snap 211a by pressing the rear end 111c of the elastic cantilever 111 along the width direction, thereby unlocking the snap 111a to allow the connector 1 and the mating connector 2 to separate. In the shown embodiment, the front end 111b of the elastic cantilever 111 is flush with the front end of the housing 10, and the rear end 111c of the elastic cantilever 111 extends beyond the rear end of the housing 10.

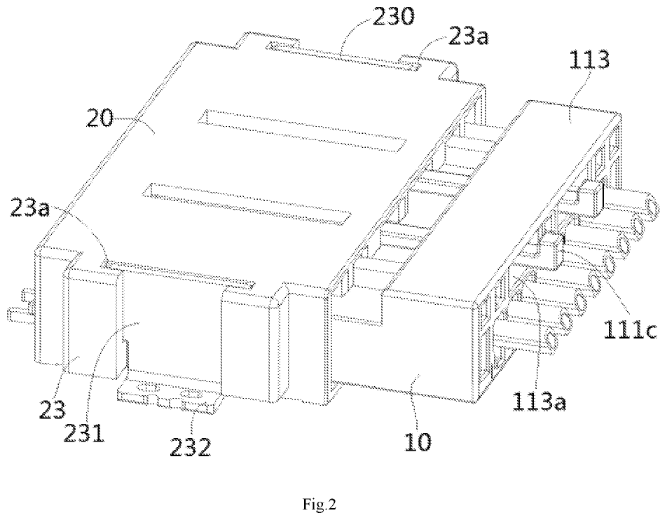

A convex portion 113, shown in FIG. 1, is formed on a top surface of a rear side of the top wall 11 of the housing 10, and a limit hole 113a shown in FIG. 2 is formed on the convex portion 113 to allow the rear end 111c of the elastic cantilever 111 to pass through. The limit hole 113a is used to limit the elastic deformation amount of the elastic cantilever 111 in the width direction and the height direction of the housing 10 to prevent excessive deformation of the elastic cantilever 111.

The connector 1 includes a pair of elastic cantilevers 111 and a pair of snaps 111a in the shown embodiment. The pair of elastic cantilevers 111 are spaced apart by a predetermined distance in the width direction, and the pair of snaps 111a are formed on two sides of the pair of elastic cantilevers 111 that face each other or are opposite to each other in a width direction.

As shown in FIG. 1, a convex rib 112 extending along the length direction is formed on the outer surface of the top wall 11 of the housing 10. The convex rib 112 is used to mate with the guide groove 212 on the mating housing 20 to guide the housing 10 to mate into the mating housing 20.

As shown in FIG. 1, a terminal installation hole 101 extending along the length direction is formed in the housing 10, and the terminal 16 is inserted in the terminal installation hole 101.

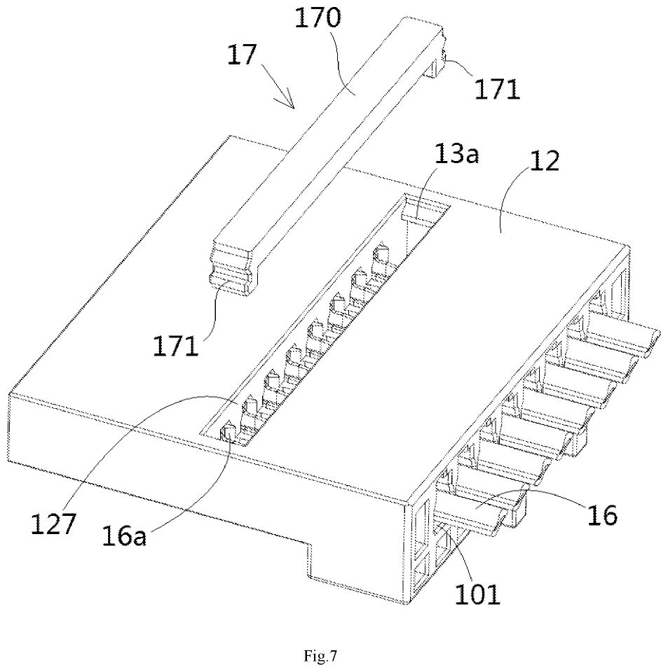

As shown in FIG. 7, a bottom slot 127 extending in the width direction is formed on the bottom wall 12 of the housing 10, and the bottom slot 127 communicates with the terminal installation hole 101. The connector 1 also includes a terminal lock 17 inserted in the bottom slot 127 and resting against the locking portion 16a of the terminal 16 to lock the terminal 16 in the housing 10. In the shown embodiment, elastic locking portions 171 are formed at both ends of the terminal lock 17, and a mating locking portion 13a corresponding to the elastic locking portion 171 is formed on the inner side of the side wall 13 of the housing 10. The elastic locking portion 171 is connected to the mating locking portion 13a to lock the terminal lock 17 in the bottom slot 127.

In the illustrated embodiment, the terminal 16 is a female terminal and the connector 1 is a female connector.

In the illustrated embodiment, the elastic cantilever 111 is integrally formed with the housing 10, so that the elastic cantilever 111 is a part of the housing 10. However, the present invention is not limited thereto. For example, the elastic cantilever 111 can be formed separately from the housing 10 and connected to the top wall 11 of the housing 10.

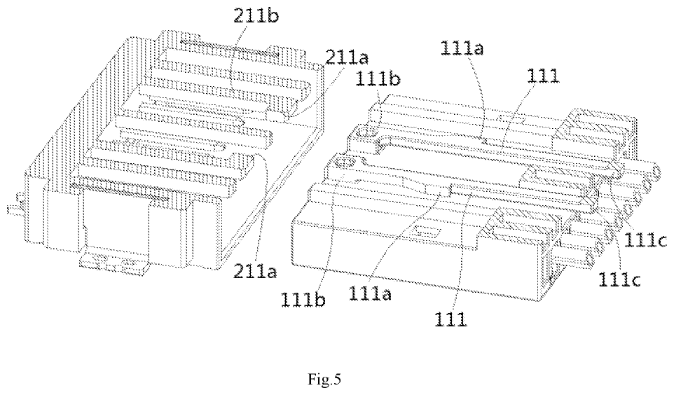

As shown in FIGS. 1 to 6, a mating connector is also disclosed for mating with the aforementioned connector 1. The mating connector 2 includes a mating housing 20 and a mating terminal 26. The mating housing 20 has an insertion cavity 201 for inserting the connector 1. The mating terminal 26 is provided in the mating housing 20 for mating with the terminal 16 of the connector 1.

As shown in FIGS. 3, 5, and 6, a convex mating snap 211a is formed on the inner surface of the top wall 21 of the mating housing 20, and the mating snap 211a is used to engage the snap 111a to lock the connector 1 and the mating connector 2 together.

A slot 211, shown in FIG. 1, extending along the length direction of the mating housing is formed on the inner side of the top wall 21 of the mating housing 20, and the elastic cantilever 111 is inserted into the slot 211. The mating snap 211a is formed on the side wall 211b of the slot 211 and protrudes along the width direction of the mating housing 20. A guide groove 212 extending along the length direction of the mating housing 20 is formed on the inner side of the top wall 21 of the mating housing 20, and the guide groove 212 is configured to mate with the convex rib 112 on the housing 10.

An observation window 213, shown in FIG. 3, is formed on the top wall 21 of the mating housing 20 to observe whether the snap 111a and the mating snap 211a have been engaged through the observation window 213.

The mating housing 20 has opposite insertion ports and end walls 24 in the length direction. The housing 10 of the connector 1 can be inserted into the insertion cavity 201 of the mating housing 20 through the insertion port. The mating terminal 26 passes through the end wall 24 of the mating housing 20 and is fixed to the end wall 24, as shown in FIG. 3. The mating terminal 26 includes a soldering pin 26a that extends outside the end wall 24 of the mating housing 20 and is adapted to be soldered to a circuit board.

As shown in FIG. 2, the mating connector 2 also includes a mounting member 230, which includes a body portion 231 and a welding portion 232. The body portion 231 of the mounting member 230 is fixed to the side wall 23 of the mating housing 20. The welding portion 232 of the mounting member 230 is adapted to be soldered to the circuit board. The mounting member 230 is typically a metal piece, and the mating housing 20 is typically a plastic piece. In the illustrated embodiment, a fixing groove 23a is formed on the side wall 23 of the mating housing 20, and the body portion 231 of the mounting member 230 is inserted in the fixing groove 23a.

In the illustrated embodiment, the mating terminal 26 of the mating connector 2 is a male terminal, and the mating connector 2 is a male connector.

In the aforementioned exemplary embodiments according to the present invention, during the process of locking or unlocking the snap and mating the snap, the elastic cantilever only needs to move in the width direction of the housing, so it does not need to occupy space in the height direction of the housing, and therefore, it is possible to reduce the height dimension of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing;
a terminal arranged in the housing; and
an elastic cantilever on an outside of a top wall of the housing and extending along a length direction of the housing, the elastic cantilever has a pair of sides opposite to each other in a width direction of the housing, a snap protruding along the width direction is formed on one of the sides of the elastic cantilever, the snap engages a mating snap formed on a mating housing of a mating connector to lock the connector and the mating connector together.

2. The connector according to claim 1, wherein the elastic cantilever has a front end and a rear end that are opposite in the length direction, the front end of the elastic cantilever is fixed to the top wall of the housing, the snap is separable from the mating snap by pressing the rear end of the elastic cantilever along the width direction.

3. The connector according to claim 2, wherein the front end of the elastic cantilever is flush with a front end of the housing, and the rear end of the elastic cantilever extends beyond a rear end of the housing.

4. The connector according to claim 3, wherein a convex portion is formed on the top wall of the housing, and a limit hole is formed on the convex portion to allow the rear end of the elastic cantilever to pass through, the limit hole limits an elastic deformation amount of the elastic cantilever in the width direction and a height direction of the housing to prevent excessive deformation of the elastic cantilever.

5. The connector according to claim 2, wherein the elastic cantilever is one of a pair of elastic cantilevers and the snap is one of a pair of snaps, the pair of elastic cantilevers are spaced apart by a predetermined distance in the width direction, and the pair of snaps are formed respectively on a pair of sides of the pair of elastic cantilevers that face each other or are opposite to each other in the width direction.

6. The connector according to claim 1, wherein a convex rib extending along the length direction is formed on an outer surface of the top wall of the housing, the convex rib mates with a guide groove on the mating housing to guide the housing to mate into the mating housing.

7. The connector according to claim 1, wherein a terminal installation hole extending along the length direction is formed in the housing, the terminal is inserted in the terminal installation hole.

8. The connector according to claim 7, wherein a bottom slot extending along the width direction is formed on a bottom wall of the housing, the bottom slot communicates with the terminal installation hole, the connector includes a terminal lock inserted in the bottom slot and resting against a locking portion of the terminal to lock the terminal in the housing.

9. The connector according to claim 8, wherein an elastic locking portion is formed at a pair of ends of the terminal lock, and a mating locking portion corresponding to the elastic locking portion is formed on an inner side of a side wall of the housing, the elastic locking portion engages the mating locking portion to lock the terminal lock in the bottom slot.

10. The connector according to claim 1, wherein the terminal is a female type terminal and the connector is a female type connector.

11. The connector according to claim 1, wherein the elastic cantilever is integrally formed with the housing so that the elastic cantilever is a part of the housing.

12. A mating connector, comprising:
a mating housing having an insertion cavity for inserting a connector, the connector has a housing, a terminal arranged in the housing, and an elastic cantilever on an outside of a top wall of the housing, a snap protrudes from a side of the elastic cantilever; and
a mating terminal provided in the mating housing for mating with the terminal, a convex mating snap is formed on an inner surface of a top wall of the mating housing, the mating snap engages the snap to lock the connector and the mating connector together.

13. The mating connector according to claim 12, wherein a slot extending along a length direction of the mating housing is formed on the inner surface of the top wall of the mating housing, the elastic cantilever is inserted into the slot, the mating snap is formed on a side wall of the slot and protrudes along a width direction of the mating housing.

14. The mating connector according to claim 12, wherein a guide groove extending along a length direction of the mating housing is formed on the inner surface of the top wall of the mating housing, the guide groove mates with a convex rib on the housing.

15. The mating connector according to claim 12, wherein an observation window is formed on the top wall of the mating housing to observe whether the snap and the mating snap have been engaged through the observation window.

16. The mating connector according to claim 12, wherein the mating terminal passes through an end wall of the mating housing and is fixed to the end wall, the mating terminal includes a soldering pin that extends outside the end wall of the mating housing and is solderable to a circuit board.

17. The mating connector according to claim 16, further comprising a mounting member having a body portion fixed to the side wall of the mating housing and a welding portion weldable to the circuit board.

18. The mating connector according to claim 17, wherein a fixing groove is formed on the side wall of the mating housing, the body portion of the mounting member is inserted in the fixing groove.

19. The mating connector according to claim 12, wherein the mating terminal is a male terminal, and the mating connector is a male connector.

20. A connector assembly, comprising:
the connector according to claim 1; and
the mating connector according to claim 12 mated with the connector.
